(19) United States
(12) Patent Application Publication
(10) Pub. No.: US 2003/0095513 A1
(43) Pub. Date: May 22, 2003

(54) Traffic management system and method for multi-carrier CDMA wireless networks

(75) Inventors: Michael Paul Woodmansee, Plano, TX (US); Kin Shing Ho, Plano, TX (US); Yves Claude Choiniere, Calgary (CA); Mazin A. Al-Shalash, Plano, TX (US)

Correspondence Address: Gregory W. Carr, CARR LAW FIRM L.L.P., 670 Founders Square, 900 Jackson Street, Dallas, TX, 75202, US

(73) Assignee: Nortel Networks Corporation

(21) Appl. No.: 10/336,304

(22) Filed: Jan. 3, 2003

Related U.S. Application Data
(62) Division of application No. 09/464,063, filed on Dec. 15, 1999.

(51) Int. Cl. H04B 7/212

(52) U.S. Cl. 370/324; 370/350

(57) ABSTRACT

A method and system for managing traffic in multi-carrier wireless communications systems is disclosed in which a paging channel of an overlay carrier frequency cell in the multi-carrier wireless communication system is eliminated. A sync channel of the overlay frequency cell is modified to direct idle mobile units served by the overlay carrier frequency cell to monitor a paging channel of an underlying carrier frequency cell. A traffic allocation algorithm is used to assign a traffic channel carrier frequency to the mobile units.

### TECHNICAL FIELD OF THE INVENTION

This invention relates generally to wireless communications systems, and more particularly to management of traffic within a multiple carrier frequency CDMA wireless communication system.

### BACKGROUND

Cellular wireless communication systems are generally known to include a plurality of base stations dispersed across a geographic service area. Each of the base stations includes at least one antenna and a Base Station Transceiver System (BTS) and provides wireless service within a respective cell. The BTS is coupled to a Base Station Controller (BSC), with each BSC serving a plurality of BTSs. The BSC is coupled to a Mobile Switching Center (MSC) that interfaces to the Public Switched Telephone Network (PSTN) and other MSCs. Together, the BTSs, BSCs, and the MSC form a wireless network that provides wireless coverage to mobile units operating within a respective service area.

Wireless communication systems operate according to various protocols. One particular protocol in place worldwide is the Code Division Multiple Access (CDMA) protocol. CDMA is a direct-sequence-spread-spectrum system in which a number, at least two, of spread-spectrum signals communicate simultaneously, each operating over the same frequency channel. In a CDMA system, each user is given a distinct Walsh Code, which identifies that user on the forward link and a distinct PN long code that identifies that user on the reverse link. For example, if a first user has a first code, g₁(t), and a second user a second code, g₂(t), etc., then a receiver located in a BTS, desiring to listen to the first user, receives at its antenna all of the energy sent by all of the users.

An initializing mobile unit operating according to CDMA will first acquire a pilot channel. After it has acquired the pilot channel, the mobile unit will acquire a sync channel message, which provides the mobile unit with necessary timing and frequency information. Once the mobile unit has the correct information from the sync channel message, it can acquire a paging channel. In CDMA, the paging channel allows the mobile unit to operate in an idle state and monitor the paging channel for information directed to the mobile unit, such as a page or an overhead -update.

One solution that has been used to overcome overcrowding in CDMA systems involves deploying multiple carriers within a single service area with the multiple carriers used to service overlay cells. With overlaying frequency coverage, some mobile units are serviced on one of the carrier frequencies while other of the mobile units are serviced on other of the carrier frequencies. By deploying multiple frequency resources, the overall capacity of the wireless communication system is increased.

However, prior art overlay carriers unnecessarily consume High Power Amplifier (HPA) power, which creates additional overhead that adds interference and reduces the capacity of the system to support mobile units. This additional overhead is caused in part by use of a paging channel on the overlay carrier frequencies in addition to the paging channel on the underlying carrier frequencies. If some of this additional overhead can be reduced or eliminated by doing away with the need for a paging channel on one or more carriers, HPA power can be conserved.

If a paging channel is removed from one or more of the overlay carrier frequencies in an effort to reduce overhead, other problems arise. For example, when a mobile unit call is released on a carrier frequency that does not have a paging channel, the mobile unit often does not return quickly enough to the underlying carrier's paging channel. This process has been shown in testing to take between 3-8 seconds, which is an unacceptable delay to users, especially when the mobile unit display indicates no service during this time. Further, upon call release, some mobile units have been observed to scan to an analog operational mode such as AMPS rather than to the CDMA underlying carrier frequency.

Other problems seen with multi-carrier systems with a paging channel on each carrier arise from overlay carrier frequencies having border zones at the borders of an overlay carrier frequency, at which zones idle mobile units are forced to handoff to an underlying carrier frequency. Currently, a Global-Service-Redirect (GSR) message is used to permit mobile units in idle mode to handoff to the underlying carrier frequency. However, the GSR message is implemented using paging channel capacity of the overlay frequency carriers. Therefore, removal of the paging channel from an overlay carrier frequency to increase system capacity by reducing overhead and interference also eliminates the overlay carrier paging channel, thus creating problems in idle mobile unit handoff at border cells.

Thus, there is a need for a system and method of operation for management of traffic in multi-carrier CDMA wireless communications systems in which paging channels of overlay carrier frequencies are eliminated in order to improve traffic capacity and reduce overhead and interference of the system and in which problems created by elimination of the paging channels are overcome.

### SUMMARY OF THE INVENTION

A wireless communications system operating according to the present invention overcomes the above-cited shortcomings relating to traffic management in multiple-carrier frequency systems as well as additional shortcomings. The wireless communications system provides wireless service to a mobile unit operating within a service area that includes at least one first cell and at least one second cell.

The at least one first cell operates on a first carrier frequency. The at least one second cell operates on a second carrier frequency. The second carrier frequency has a sync channel to direct idle mobile units operating on the second carrier frequency to a paging channel of the first carrier frequency.

In a typical construction, overlaying wireless coverage is provided within the second cell via the second carrier frequency, which coverage overlays the wireless coverage of the first carrier frequency of the at least one first cell. In such construction, the at least one second cell overlays the at least one first cell so that the first carrier frequency is supported throughout the service area and the second carrier frequency is supported throughout or in a portion of the service area.

Multi-carrier border cells support both the first carrier frequency and the second carrier frequency and form a border between portions of the service area that support only the first carrier frequency and those that support both the first and the second carrier frequencies. Operation in the multi-carrier border cells enables mobile units to maintain service between areas supported by multiple-carrier frequencies and areas supported by a single-carrier frequency.

Of course, the teachings of the present invention can be readily applied to wireless communications systems that support in excess of two carrier frequencies. Further, multi-carrier border cells can lie between separate systems, one which supports multiple carrier frequencies and one which does not. In either case, the multi-carrier border cells provide transition operations for mobile units moving between multi-carrier areas and single carrier areas or between areas supporting different sets of carriers.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

For a more complete understanding of the present invention and the advantages thereof, reference is now made to the following description taken in conjunction with the accompanying drawings, in which like reference numbers indicate like features and wherein:

FIG. 1 is a diagram illustrating a wireless communications system constructed according to the present invention;

FIG. 2 is a diagram illustrating a layout of a wireless communication system having multiple carrier cells, border cells, and single frequency cells;

FIG. 3 is a logic flow diagram illustrating direction of an idle mobile unit operating on an overlay carrier frequency to a paging channel of an underlying carrier frequency according to the invention;

FIG. 4 is a diagram illustrating sectorized cells at a border region;

FIG. 5 is a flow diagram illustrating idle mode handoff at a border cell according to the invention; and

FIG. 6 is a graphic illustration of the total BTS transmission power (Tₓ) for CDMA carrier f₂ with a paging channel and CDMA carrier f₃ without a paging channel and the increase in usable capacity in serving mobile units achieved by a preferred embodiment of the present invention.

### DETAILED DESCRIPTION

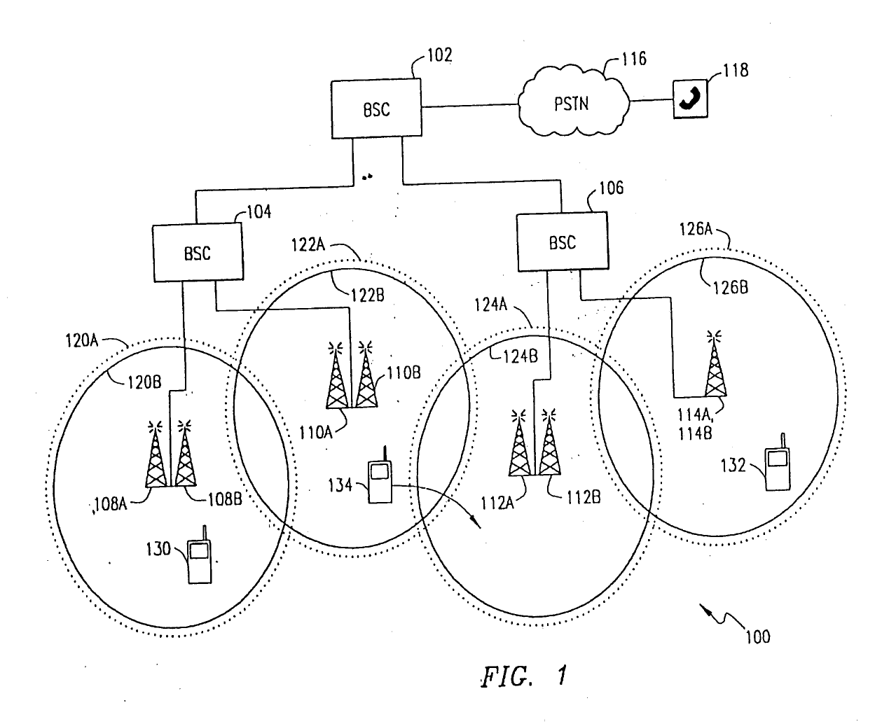

FIG. 1 illustrates a wireless communications system 100 constructed according to the present invention that includes a plurality of cells serviced by multiple carrier frequencies. In the illustrated embodiment, the wireless communications system 100 operates according to a code-division-multiple-access (CDMA) protocol, in particular, the TIA/EIA/IS95 and ANSI J-STD 008 CDMA standard, modified as required to accomplish the teachings of the present invention. The principles of the present invention also apply to other wireless communications systems operating according to other protocols, as well, in which multiple carrier frequencies overlay one another to increase the capacity of the wireless communication system 100.

The wireless communication system 100 includes a mobile switching center (MSC) 102, base station controllers (BSCs) 104 and 106, and a plurality of base stations, each of which includes an antenna and a Base Station Transceiver System (BTS). The MSC 102 couples the wireless communication system 100 to the Public Switched Telephone Network (PSTN) 116. The wireless communication system services calls between device 118 connected to the PSTN 116, for example, and any of a plurality of mobile units 130, 132, and 134 operating within the wireless communications system. The wireless communications system 100 also services calls between the plurality of mobile units 130, 132, and 134.

BTSs 108A, 108B, 110A, and 110B couple to BSC 104, while BTSs 112A, 112B, 114A, and 114B couple to BSC 106. The BTSs are constructed such that two carrier frequencies are supported within the wireless communications system. BTS 108A provides service on a first carrier frequency within cell 120A and BTS 108B provides service on a second carrier frequency within cell 120B, cell 120A substantially overlaying cell 120B. Likewise, BTS 110A provides wireless coverage on the first carrier frequency in cell 122A and BTS 110B provides wireless coverage on the second carrier frequency in overlay cell 122B. Further, BTSs 112A and 114A provide wireless coverage on the first carrier frequency in cells 124A and 126A, respectively, and BTSs 112B and 114B provide wireless coverage on the second carrier frequency in overlay cells 124B and 126B, respectively. By providing wireless coverage on the two carrier frequencies, the capacity provided by the wireless communication system 100 is approximately double that which would be available with a single carrier frequency. Each of the cells within the wireless communication system 100 can also be divided into sectors as is generally known.

The wireless communication system 100 was originally constructed to provide coverage on a single carrier frequency and was then expanded to support a second carrier frequency due to an increase in load growth within the service area. To support operation on the second carrier frequency, additional equipment, such as radios, Base Transceiver Stations (BTSs), towers, etc. . . . were added to service BTSs 108B, 110B, and 112B. However, BTS 114B is serviced by the same tower as BTS 114A, with an antenna added to the existing tower to support BTS 114B, BTSs 114A and 114B providing service on the first and second carrier frequencies, respectively. Moreover, the functions of BTS 114A and BTS 114B can be achieved by a single multi-carrier BTS capable of operating on multiple carrier frequencies; thus, the present invention can be implemented using single-carrier BTSs (on separate or shared towers) and/or multiple-carrier BTSs. The principles of the present invention apply equally to wireless communication systems constructed originally to support two or more carrier frequencies.

In an example of an operation of the wireless communication system 100 in accordance with the present invention, mobile unit 130 is in active mode on the second carrier frequency during a call with, for example, mobile unit 132 or 134 or device 118. In a typical construction, a traffic channel on the second carrier frequency has been assigned to mobile unit 130 in cell 120B using a traffic-allocation algorithm such as the Multi-Carrier-Traffic-Allocation (MCTA) method and system disclosed in greater detail in the patent application entitled “Traffic Allocation and Dynamic Load Balancing in a Multiple Carrier Cellular Wireless Communication System,” filed Mar. 6, 1998, and having Ser. No. 09/036,191, which is hereby incorporated in its entirety by reference herein. However, it will be appreciated that the present invention can be implemented using other traffic allocation algorithms other than MCTA, such algorithms typically being used to distribute calls across carriers. The second carrier frequency being used by mobile unit 130 has been configured in cell 120B to not have a paging channel.

In accordance with the teachings of the present invention, after mobile unit 130 releases a call on the second carrier frequency, it acquires the pilot channel of the second carrier frequency, and then receives a sync channel message on the second carrier frequency. The sync channel message directs the mobile unit 130 to tune to the first carrier frequency, which is transmitted by BTS 108A. It should be noted that the process described above of mobile unit 130 receiving a sync channel message on the second carrier frequency directing it to tune to the first carrier frequency is begun any time mobile unit 130 initializes on the second carrier frequency, such as, for example, when mobile unit 130 powers up or releases a call. In response to the sync channel message, mobile unit 130 tunes to the first carrier frequency, which is transmitted by BTS 108A, and monitors a paging channel on the first carrier frequency.

Although the process of directing a mobile unit that is in idle mode and operating on the second carrier frequency has been illustrated with respect to mobile unit 130, the above-described process is equally applicable to mobile units 132 and 134 or any mobile unit transitioning to idle mode on a second carrier frequency that has been configured in accordance with the present invention to not include a paging channel.

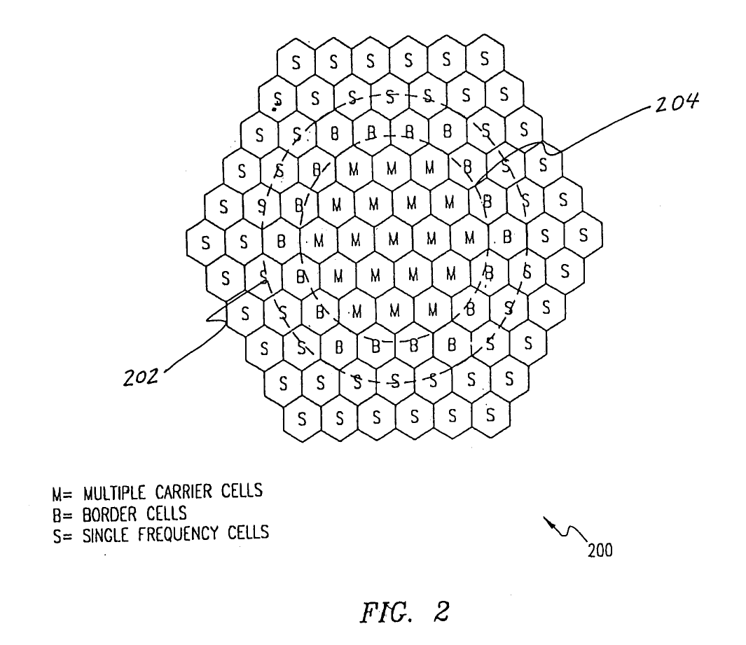

FIG. 2 illustrates a plurality of cells in a wireless communications system 200 constructed according to the present invention. As is shown, the wireless communication system 200 includes a plurality of multiple carrier frequency cells (M), a plurality of border cells (B), and a plurality of single carrier frequency cells (S). In the installation illustrated, the multiple carrier frequency cells support two or more carrier frequencies while the single carrier frequency cells support only a single carrier frequency. A typical installation of such a system 200 can be in a densely populated downtown area such as the greater Dallas area wherein multiple carrier frequency cells are placed in areas where load density exceeds the capacity that could be served by a single carrier frequency cell. In geographic areas of high density of use, the multiple carrier frequency cells are installed to increase the capacity of those particular cells. However, in the outlying areas, the single frequency cells provide sufficient capacity to serve the needs of the users that operate within those cells.

Area 1 is defined by line 204 to include the multiple carrier frequency cells, while Area 2 is defined by line 202 to include only the single frequency cells, such single frequency cells lying outside of circle 202. The area between circles 202 and 204 defines the border zone for the system 200. Mobile calls within Area 2 (outside of circle 202) must always originate on carrier frequency f₁ and are allocated resources only on f₁. Mobile unit calls within Area 1 can originate on either carrier frequency f₁ or carrier frequency f₂ (the two carriers supported within Area 1) with resources allocated on f₁ or f₂. Finally, mobile unit calls originating within the border zone between circles 202 and 204 can originate on carrier frequency f₁ or f₂ and are accordingly allocated resources on frequency f₁ or f₂.

In accordance with an embodiment of the present invention, mobile units operating within system 200 that are in idle mode can utilize only a paging channel of the carrier frequency f₁, regardless of whether the mobile units are in Area 1, Area 2, or the border zone. This is the case because, in this embodiment of the present invention, all carrier frequencies in system 200 other than f₁ (e.g., f₂) have been configured to not include a paging channel. While FIG. 2 illustrates a system with only two carrier frequencies and only one carrier frequency f₂ without a paging channel, it should be understood that any number of carrier frequencies with and without active paging channels can be configured in accordance with the present invention to meet the needs of a multi-carrier system.

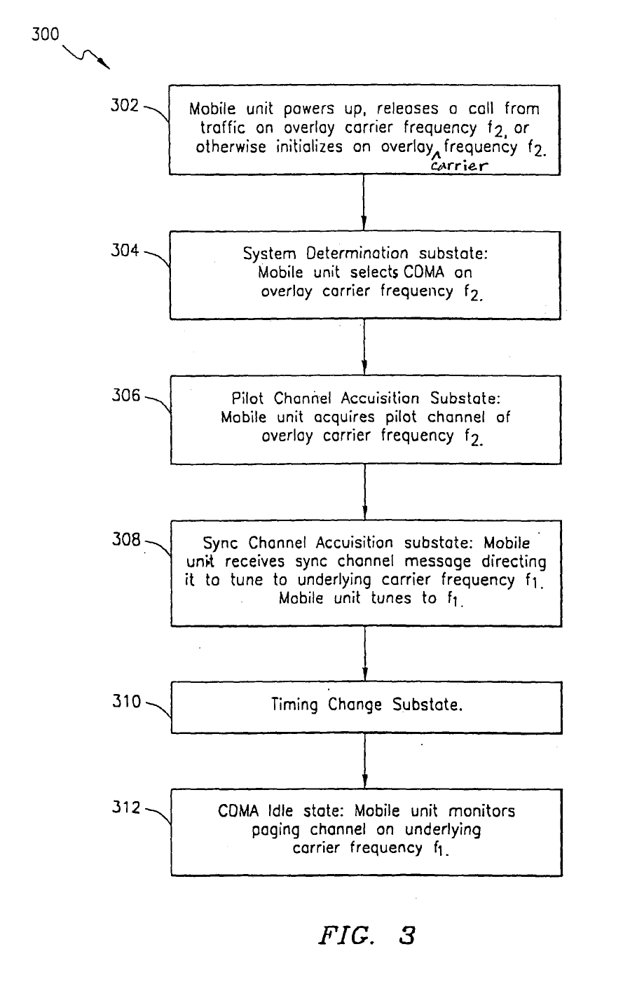

FIG. 3 illustrates in greater detail direction of a mobile unit that has initialized on an overlay carrier frequency f₂ to a paging channel of a primary carrier frequency f₁ according to the present invention. The sync channel message is used to direct mobile units that have initialized on overlay carrier frequency f₂ to the underlying carrier frequency f₁.

Because there is no paging channel on overlay carrier frequency f₂, the channel needs to be configured to prevent mobile units from hashing to f₂. However, for example, a mobile unit could initialize on overlay frequency f₂ if a traffic allocation algorithm had previously directed it to a traffic channel on f₂ for a call and the mobile unit had subsequently ended the call on f₂. Upon ending the call, the mobile unit would acquire the sync channel message on f₂, from which it would obtain instructions in accordance with the teachings of the present invention to acquire the paging channel on f₁.

In addition, a mobile unit could, for example, enter a service area and power up, whereupon a PRL (Provide Roaming List) of the mobile unit could direct the mobile unit to overlay carrier frequency f₂. A mobile unit could also be directed to f₂ by an algorithm within the mobile unit (such as one utilizing a most recently used list).

Referring now to FIG. 3, operation of process 300 commences at step 302, wherein the mobile unit powers up, releases a call from traffic on overlay carrier frequency f₂, or otherwise initializes on f₂. Next, at step 304, the mobile unit enters a System Determination substate, wherein the mobile unit selects CDMA on overlay carrier frequency f₂. Next, at step 306, the mobile unit enters the Pilot Channel Acquisition substate, wherein the mobile unit acquires the pilot channel of f₂. In a preferred embodiment, overlay carriers have the same Pilot Pseudo-random Noise offset (Pilot_PN) as the underlying carrier. The pilot channel is transmitted continuously as all 0's on Walsh code 0. The pilot is first spread by the Walsh code 0 then is spread by a quadrature pair of short PN sequences, thus creating the Pilot_PN. This is done in order to ensure that mobile units have the correct timing and phase reference when they are directed to the underlying carrier. When mobile units are directed to the underlying carrier using the sync channel message, they are provided the Pilot_PN that they need to search for so that mobile units are able to find the pilot channel on the underlying carrier. If mobile units cannot find the pilot channel on the underlying carrier, they will not be able to find the underlying channel's paging channel, and will then reinitialize on the underlying carrier. Such reinitialization is undesirable because it takes a longer period of time than if the mobile unit already has the correct Pilot_PN upon being redirected to the underlying carrier.

From step 306, operation proceeds to step 308, wherein the mobile unit enters the Sync Channel Acquisition substate and receives a sync channel message on f₂, which message directs the mobile unit to tune to the underlying carrier frequency f₁. In a preferred embodiment, a CDMA_FREQ field of the sync channel message on f₂ is configured with the frequency of the paging channel of f₁ and a Pilot_PN field of the sync channel message on f₂ contains the Pilot_PN of f₁. In response to the sync channel message on f₂, the mobile unit tunes to f₁.

Next, at step 310, the mobile unit enters the Timing Change substate. Steps 304-310 are collectively referred to as the Initialization State. From step 310, the process proceeds to step 312, wherein the mobile unit enters the CDMA Idle State and monitors the paging channel on the underlying carrier frequency f₁.

In a preferred embodiment, the paging channel of f₁ includes a Channel List Message configured with only the frequency of the paging channel of f₁, which prevents idle mobile units from searching for a paging channel on overlay frequencies that do not have a paging channel. If channel numbers of carriers without a paging channel were included in the Channel List message of the paging channel of f₁, mobile units could, for example, use an internal algorithm specified by the IS-95 standard and, based on calculations using ESN and PN long codes, choose a carrier without a paging channel.

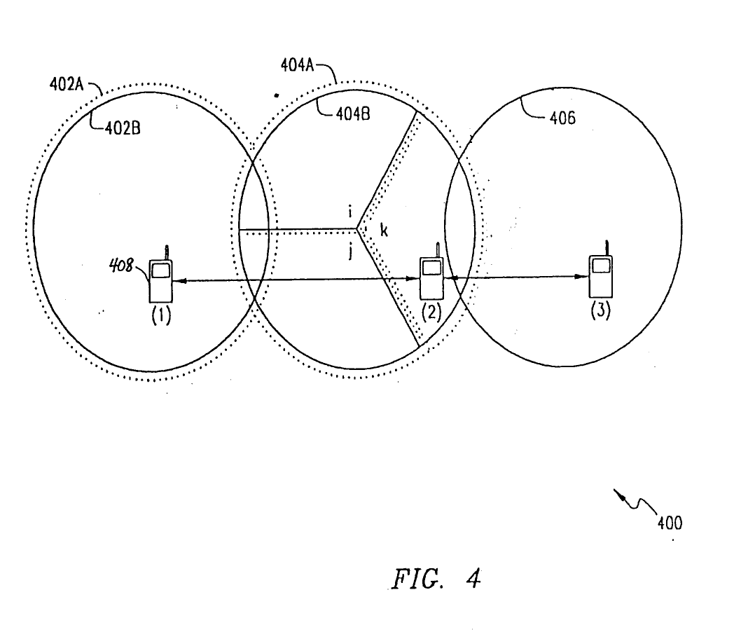

FIG. 4 illustrates a border region 400 of a wireless communications system. The border region 400 includes multiple carrier frequency cells that include underlying cell 402A and overlay cell 402B operating on a first carrier frequency f₁ and a second carrier frequency f₂, respectively. The border region 400 also includes cells 404A and sectorized cell 404B, cell 404A operating on the first carrier frequency f₁ and cell 404B operating on the second carrier frequency f₂, cell 404B substantially overlaying cell 404A. As is shown, cells 404A and 404B each include sectors i, j, and k. Further, the border region 400 also includes single carrier frequency cell 406, cell 406 operating on the first carrier frequency f₁, and adjoining cell 404B sector k.

In accordance with an embodiment of the present invention, cells 402A and 402B, operating on f₁ and f₂, respectively, each have a paging channel that mobile units, such as mobile unit 408, can receive messages on while in idle-mode operation in cells 402A and 402B, respectively. In addition, cell 404A, which operates on f₁, and sectors i and j of cell 404B, which operate on f₂, each have a paging channel. However, cell 404B sector k, which operates on f₂ and which borders cell 406, does not have a paging channel. Cell 404B sector k is a border cell, a border cell being defined as a cell that is the last multi-carrier cell that a mobile unit will encounter before it enters into a cell that is only supported by the underlying carrier frequency. Cell 406, which operates only on f₁, has a paging channel on f₁.

Also shown in FIG. 4 is a mobile unit 408 that can reside in positions 1, 2, and 3 during its operation. When the mobile unit 408 is operating in idle mode in position 1, it can operate using either f₁ of cell 402A or f₂ of cell 402B and receive messages on a paging channel of f₁ or f₂. With the mobile unit 408 operating in idle mode on f₁ and moving from position 1 to position 2 to position 3, an idle-mode handoff is performed from cell 402A to cell 404A sector j, to cell 404A sector k, and then to cell 406 on f₁.

On the other hand, if mobile unit 408 is operating in idle mode on f₂ and is moving from position 1 to position 2 to position 3, an idle-mode handoff will be performed from cell 402B to cell 404B sector j and to cell 404B sector k on f₂. However, in order for mobile unit 408 to be handed off to cell 406, provision must be made for a handoff from cell 404B sector k to cell 406. Mobile unit 408 may not idle handoff directly to cell 406, because cell 406 does not support f₂, and testing has shown that mobile units do not perform well when idle handing off from one frequency to another, with such handoffs often taking 3-8 seconds.

Therefore, in accordance with an embodiment of the present invention, as mobile unit 408 hands off from cell 404B sector j to cell 404B sector k, a neighbor list message is broadcast to mobile unit while it is being served by cell 404B sector j, the neighbor list message instructing mobile unit 408 that the paging channel configuration of cell 404B sector k is unknown. In response to the neighbor list message, mobile unit 408 acquires the sync channel message of f₂, which directs mobile unit 408 to monitor the paging channel of f₁; thereafter mobile unit 408 operates in idle mode on f₁ in cell 404A sector k. From cell 404A sector k, mobile unit 408 performs an idle-mode handoff to cell 406.

Although the idle mode handoff process for mobile unit 408 has been illustrated with only the border cell 404B sector k being configured without a paging channel, it will be apparent that numerous combinations and configurations of multi-carrier cells with and without paging channels can be implemented in accordance with the teachings of the present invention so as to optimize performance of multi-carrier CDMA wireless systems.

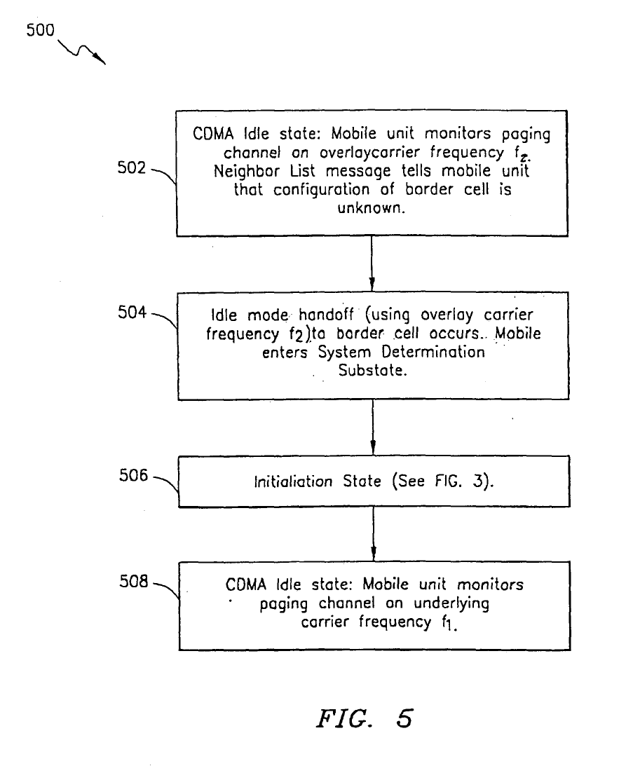

FIG. 5 illustrates in more detail the process of mobile unit idle mode handoff at a border cell such as cell 404B sector k of FIG. 4, with particular application to a CDMA cell. A border cell is a cell that is the last multi-carrier cell that a mobile unit will encounter before it enters into a cell that is only supported by the underlying carrier frequency. Operation of process 500 commences at step 502, wherein the mobile unit enters the CDMA idle state and monitors the paging channel of an overlay carrier frequency f₂ and a neighbor list message is broadcast to tell the mobile unit that the paging channel configuration of the border cell is unknown.

From step 502, operation proceeds to step 504, wherein idle mode handoff of the mobile unit to the border cell occurs and the mobile unit enters the System Determination substate. Following step 504, operation proceeds to step 506, wherein the mobile unit enters the Initialization State described in FIG. 3. From step 506, the process proceeds to step 508. At step 508, the mobile unit enters the CDMA idle state, wherein it monitors the paging channel of the underlying carrier frequency f₁.

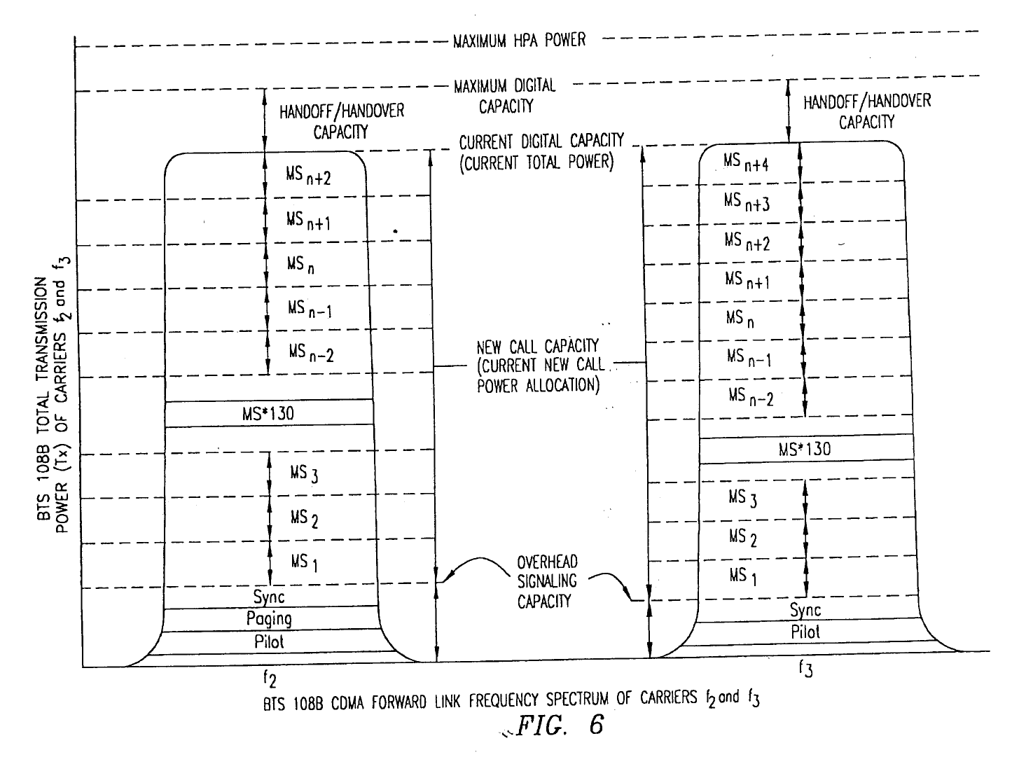

Referring now to FIG. 6, shown is a graphic representation of the total radio frequency power transmitted by, for example, BTS 108B of FIG. 1 over CDMA overlay carrier frequencies f₂ and f₃, f₂ illustrating an overlay carrier with a paging channel and f₃ illustrating an overlay carrier without a paging channel in accordance with the teachings of the present invention. Although FIG. 6 includes only carriers f₂ and f₃, it will be apparent that this discussion of carriers f₂ and f₃ is applicable to other carriers over which a BTS configured in accordance with the present invention transmits, such as f₄, f₅, f₆ through n carriers. The vertical axis of the graph represents the total power of the transmission at a given time, while the horizontal axis represents the breadth of frequencies comprising the carriers f₂ and f₃.

The total transmission power Tₓ is the sum of power allocated to each of f₂ and f₃ carrier for overhead (e.g., pilot, sync, and paging channels for f₂, and pilot and paging channels for f₃), new calls, and combined soft and softer handoffs. In general, the capacity of the carriers f₂ and f₃ to handle each of the foregoing general categories of transmissions is directly related to the allocation of power to each. The BTS 108B is programmed or controlled to limit the total transmission power Tₓ so as not to exceed the BTS 108B maximum high power amplifier (HPA) power rating. Thus, the total power Tₓ and the corresponding capacity of the forward link comprising part of the f₂ and f₃ carriers is limited by the maximum HPA power. In general, the total forward link power capacity available to BTS 108B for new calls and the combination of soft and softer handoffs is that portion of the total power Tₓ above the power allocation for overhead capacity and below the maximum HPA power.

When the paging channel of an overlay carrier frequency such as f₂ is eliminated in accordance with the teachings of the present invention, the depiction of f₃ in FIG. 6 illustrates how additional capacity is made available for overlay carrier f₃ to service additional mobile units and/or perform handoffs and handovers as compared to f₂. This additional capacity results from a reduction in overhead power allocation once the paging channel of the overlay carrier has been eliminated.

It can be demonstrated that an increase in available overhead power sufficient to permit the overlay carrier frequency cell to support one or more additional mobile calls results from elimination of the paging channel. In addition, elimination of the paging channel from an overlay carrier frequency reduces interference, which further increases available capacity of the system. For example, f₃ is shown as able to support two more mobile units than f₂ as a result of elimination of the paging channel from f₃.

With a paging channel present on an overlay carrier, standard overhead power per sector of the pilot channel, paging channel, and sync channel is represented by the following equation:

Overhead power=Pilotpower+Syncpower+(1−0.5PRAT)Pagingpower (e.g., f₂)

Similarly, when the paging channel is eliminated, the resulting reduced overhead power allocation is represented by the following equation:

Overhead power(e.g., f₃)=Pilotpower+Syncpower

Thus, the overhead power savings from elimination of the paging channel can be represented as follows:

Overhead power savings=(1−0.5PRAT)Pagingpower (e.g., f₂-f₃)

(PRAT is a configuration parameter on the BTS that sets the paging rate (bandwidth). Full-rate paging is 9600 bps, and half-rate paging is 4800 bps. The datafill values are 0 and 1 respectively.)

Although the invention has been described with reference to specific CDMA system embodiments, these descriptions are not meant to be construed in a limiting sense. Various modifications of the disclosed embodiments, as well as alternative embodiments of the invention, will become apparent to persons skilled in the art upon reference to the description of the invention. It is, therefore, contemplated that the claims will cover any such modifications or embodiments that fall within the true scope and spirit of the invention.

What is claimed is:

1. A wireless communication system that provides wireless service to at least one mobile unit operating within a service area, the wireless communications system comprising:
at least one first cell for communicating with at least one mobile unit, the at least one first cell operating on a first carrier frequency, the first carrier frequency including a paging channel and a sync channel; and
at least one second cell for communicating with the at least one mobile unit, the at least one second cell operating on a second carrier frequency, the second carrier frequency including a sync channel that directs at least one of the at least one mobile units to tune to the paging channel of the first carrier frequency.

2. The system of claim 1 further comprising at least one base station serving at least one of the at least one first cell and at least one of the at least one second cell.

3. The system of claim 1 further comprising at least one base station capable of operating on the first carrier frequency and on the second carrier frequency, the at least one base station serving at least one of the at least one first cell and at least one of the at least one second cell.

4. The system of claim 1 further comprising at least one first base station serving at least one of the at least one first cell and at least one second base station serving at least one of the at least one second cell.

5. The system of claim 1 further comprising at least one base station controller coupled to at least one first base station serving at least one of the at least one first cell and to at least one second base station serving at least one of the at least one second cell.

6. The system of claim 1 further comprising at least one mobile switching center coupled to at least one base station controller, the at least one base station controller coupled to at least one base station, the at least one base station serving at least one of the at least one first cell and at least one of the at least one second cell.

7. The system of claim 1 further comprising at least one mobile switching center coupled to at least one base station controller, the at least one base station controller coupled to at least one first base station operating on the first carrier frequency and to a second base station operating on the second carrier frequency.

8. The system of claim 1, wherein a CDMA_FREQ field of a sync channel message of the sync channel of the second carrier frequency contains the frequency of the paging channel of the first carrier frequency.

9. The system of claim 1, wherein the paging channel of the first carrier frequency includes a Channel List Message in which every paging channel listed therein is a paging channel of the first carrier frequency.

10. The system of claim 1 further comprising a traffic allocation algorithm.

11. The system of claim 1 further comprising Multi-Carrier Traffic Allocation (MCTA).

12. The system of claim 1 wherein the system utilizes code division multiple access (CDMA).

13. The system of claim 1 wherein a Pilot_PN field of a sync channel message of the sync channel of the second carrier frequency contains a Pilot_PN of the first carrier frequency.

14. A method of operation of a wireless communications system comprising the steps of:
a mobile unit initializing on a first carrier frequency; and
transmitting a message to the mobile unit on a sync channel of the first carrier frequency, the message directing the mobile unit to tune to a paging channel of a second carrier frequency.

15. The method of claim 14 wherein the step of initializing is preceded by the mobile unit being powered up.

16. The method claim 14 wherein the step of initializing is preceded by a call release of the mobile unit.

17. The method of claim 14 further comprising the step of, in response to the message directing the mobile unit to tune to the paging channel of the second carrier frequency, tuning the mobile unit to the paging channel of the second carrier frequency.

18. The method of claim 14 further comprising the steps of:
in response to the message directing the mobile unit to tune to the paging channel of the second carrier frequency, tuning the mobile unit to the paging channel of the second carrier frequency; and
monitoring the paging channel of the second carrier frequency.

19. The method of claim 14 wherein a sync channel message of the sync channel of the first carrier frequency is configured with a CDMA_FREQ field directing the mobile unit to the paging channel of the second carrier frequency.

20. The method of claim 14 wherein the first carrier frequency does not have a paging channel.

21. The method of claim 14 wherein the system utilizes code division multiple access (CDMA).

22. The method of claim 14 wherein a Pilot_PN field of a sync channel message of the sync channel of the first carrier frequency contains a Pilot_PN of the second carrier frequency.

23. A method of enhancing the performance of a wireless telecommunications system comprising the steps of:
configuring a sync channel of at least one non-primary carrier frequency with a paging channel of at least one primary carrier frequency;
configuring the at least one non-primary carrier frequency to not include a paging channel; and
configuring a channel list message of the at least one primary carrier frequency with the paging channel of the at least one primary carrier frequency.

24. The method of claim 23 wherein a sync channel message of the sync channel of the non-primary carrier frequency includes a CDMA_FREQ field directing at least one mobile unit to the paging channel of the primary carrier frequency.

25. The method of claim 23 wherein the non-primary carrier frequency does not include a paging channel.

26. The method of claim 23 wherein the system utilizes code division multiple access (CDMA).

27. The method of claim 23 wherein a Pilot_PN field of a sync channel message of the sync channel of the non-primary carrier frequency contains a Pilot_PN of the primary frequency.

28. A method of performing an idle-mode handoff in a wireless communication system comprising the steps of:
sending a neighbor list message to at least one mobile unit operating on a non-primary carrier frequency in a first cell, the neighbor list message instructing the at least one mobile unit to acquire a sync channel of a second cell, the second cell operating on the non-primary frequency and bordering the first cell;
in response to the neighbor list message, the at least one mobile unit acquiring the sync channel of the second cell.

29. The method of claim 28 further comprising the step of using the sync channel of the second cell to direct the at least one mobile unit to a paging channel of at least one primary carrier frequency.

30. The method of claim 28 wherein the second cell does not contain a paging channel.

31. The method of claim 29 wherein the paging channel of the at least one primary carrier frequency includes a Channel List Message in which every paging channel listed therein is a paging channel of the primary carrier frequency.

32. The method of claim 28 wherein a sync channel message of the sync channel of the second cell includes a CDMA_FREQ field with the paging channel of the primary carrier frequency.

33. The method of claim 28 wherein the system utilizes code division multiple access (CDMA).

34. The method of claim 28 wherein the system utilizes a traffic allocation algorithm.

35. The method of claim 28 wherein the system utilizes Multi-Carrier Traffic Allocation (MCTA).

36. The method of claim 29 wherein a Pilot_PN of a sync channel message of the sync channel of the second cell contains a Pilot_PN of the at least one primary carrier frequency.
